(19) United States
(12) Patent Application Publication
(10) Pub. No.: US 2008/0131251 A1
(43) Pub. Date: Jun. 5, 2008

(54) APPARATUS FOR CONVEYING AND STORING ARTICLES

(75) Inventors: Naoto Sato, Isesaki-shi (JP); Masaru Tsunoda, Isesaki-shi (JP); Toshihiko Kurihara, Isesaki-shi (JP); Chiaki Kobayashi, Isesaki-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: SANDEN CORPORATION, Isesaki-shi (JP)

(21) Appl. No.: 11/948,942

(22) Filed: Nov. 30, 2007

(30) Foreign Application Priority Data
Nov. 30, 2006 (JP) 2006323424

(51) Int. Cl. B65G 1/04

(52) U.S. Cl. 414/660

(57) ABSTRACT

An apparatus for conveying and storing articles comprises an inlet/outlet slot, a plurality of storage spaces stacked vertically and transversely, and a movable bucket for conveying an article from the inlet/outlet slot to one of the storage spaces and conveying an article from one of the storage spaces to the inlet/outlet slot. The bucket comprises a bucket body, an arm projecting from the bucket body, a first driving roller provided on the arm and a guide projecting from the bucket body. The first driving roller and the guide enter one of the storage spaces to clamp an article, thereby enabling the article to be transferred from the bucket into the storage space and be taken from the storage space into the bucket.

### BACKGROUND OF THE INVENTION

The present invention relates to an apparatus for conveying and storing articles.

Japanese Patent Laid-Open Publication No. 2000-016523 discloses an apparatus for conveying and storing articles comprising an inlet/outlet slot, a plurality of storage spaces stacked vertically and transversely and a movable bucket for conveying an article from the inlet/outlet slot to one of the storage spaces and conveying an article from one of the storage spaces to the inlet/outlet slot, wherein the bucket comprises a bucket body, an arm projecting from the bucket body and a driving roller provided on the arm, and wherein the driving roller enters one of the storage spaces to clamp an article, thereby enabling the article to be transferred from the bucket body into the storage space and be taken from the storage space into the bucket body.

In the aforementioned apparatus, the driving roller enters the storage space and collaborates with a structural member of the storage space to clamp a disk, thereby taking the disk from the storage space into the bucket body and transferring the disk from the bucket body into the storage space. The structural member of the storage space is liable to deform because it is usually made of a thin plate. Therefore, the aforementioned apparatus includes shortcomings in that the clamp of the disk is liable to become unstable, the taking of the disk into the bucket body is liable to become difficult, and the transfer of the disk into the storage space is liable to become difficult.

### SUMMARY OF THE INVENTION

An object of the present invention is to provide an apparatus for conveying and storing articles comprising an inlet/outlet slot, a plurality of storage spaces stacked vertically and transversely, and a movable bucket for conveying an article from the inlet/outlet slot to one of the storage spaces and conveying an article from one of the storage spaces to the inlet/outlet slot, wherein the bucket comprises a bucket body, an arm projecting from the bucket body and a driving roller provided on the arm, and wherein the driving roller enters one of the storage spaces to clamp an article, thereby enabling the article to be transferred from the bucket body into the storage space and be taken from the storage space into the bucket body, and wherein the roller entering the storage space can clamp the article without collaborating with a structural member of the storage space.

In accordance with the present invention, there is provided an apparatus for conveying and storing articles comprising an inlet/outlet slot, a plurality of storage spaces stacked vertically and transversely, and a movable bucket for conveying an article from the inlet/outlet slot to one of the storage spaces and conveying an article from one of the storage spaces to the inlet/outlet slot, wherein the bucket comprises a bucket body, an arm projecting from the bucket body, a first driving roller provided on the arm and a guide projecting from the bucket body, and wherein the first driving roller and the guide enter one of the storage spaces to clamp an article, thereby enabling the article to be transferred from the bucket into the storage space and be taken from the storage space into the bucket.

In the apparatus of the present invention, the first driving roller provided on the arm projecting from the bucket body and the guide projecting from the bucket body enter one of the storage spaces to clamp an article. Thus, the first driving roller can clamp the article without collaborating with a structural member of the storage space. Therefore, the article can be reliably taken from the storage space into the bucket body and transferred from the bucket body into the storage space even if the structural member of the storage space deforms a little.

In a preferred embodiment of the present invention, vertically adjacent tiers of storage spaces are laterally staggered.

When vertically adjacent tires of storage spaces are laterally staggered, the storage space can have a large height at the transverse middle. Therefore, the first driving roller can easily enter the storage space if only it enters the transverse middle of the storage space with large height. When vertically adjacent tires of storage spaces are staggered laterally to enlarge the height of the storage space at the transverse middle, there can be provided a compact apparatus for conveying and storing articles, comprising a stacked assembly of storage spaces compact in vertical size and a bucket provided with a conveying mechanism for transferring an article from the bucket into the storage space and taking the article from the storage space into the bucket.

In another preferred embodiment of the present invention, each of the storage spaces is provided with a shelf for supporting the article and the shelf is provided with an upward projection at the end close to the inlet of the storage space.

In another preferred embodiment of the present invention, each of the storage spaces is provided with a shelf for supporting the article and the shelf is slanted downward in the direction to the rear end of the storage space.

When the shelf for supporting the article is provided with an upward projection at the end close to the inlet of the storage space, or the shelf for supporting the article is slanted downward in the direction to the rear end of the storage space, the article can be kept from falling out of the storage space even if the apparatus for conveying and storing articles is inclined toward the inlet of the storage space for some reason.

In another preferred embodiment of the present invention, the guide is located below the first driving roller and provided with a downward slant upper surface at the tip portion.

The downward slant upper surface at the tip portion of the guide can guide the end portion of the article in the storage space to the first driving roller.

In another preferred embodiment of the present invention, the crest of the downward slant upper surface of the guide is located above the shelf when the first driving roller and the guide enter one of the storage spaces to transfer the article from the bucket body into the storage space, or take the article from the storage space into the bucket body.

The downward slant upper surface of the guide located above the shelf at the crest can reliably guide the article from the shelf to the first driving roller and transfer the article from the first driving roller to the shelf even if the shelf is provided with an upward projection at the end close to the inlet of the storage space or the shelf is slanted downward in the direction to the rear end of the storage space.

In another preferred embodiment of the present invention, the arm projecting from the bucket body can swing between a rest position where the first driving roller and the guide do not clamp the article and a working position where the first driving roller and the guide clamp the article. The swing of the arm from the working position to the rest position is detected by a sensor, thereby detecting the completion of the operation for transferring the article from the bucket body into the storage space and the completion of the operation for taking the article from the storage space into the bucket body.

The first driving roller and the guide move from one condition wherein they clamp the article to another condition wherein they do not clamp the article. The arm projecting from the bucket body swings accompanying the change of the aforementioned conditions. Therefore, the completion of the operation for transferring the article from the bucket body into the storage space and the completion of the operation for taking the article from the storage space into the bucket body can be reliably detected by detecting the swing of the arm.

In another preferred embodiment of the present invention, the first driving roller enters one of the storage spaces, while rotating in the direction for taking the article into the bucket body, to take the article into the bucket body.

When the first driving roller enters one of the storage spaces, while rotating in the direction for taking the article into the bucket body, the first driving roller and the guide can smoothly clamp the end portion of the article in the storage space.

In another preferred embodiment of the present invention, the circumferential speed of the outer circumferential surface of the rotating first driving roller is larger than the advancing speed of the first driving roller into the storage space.

When the circumferential speed of the outer circumferential surface of the rotating first driving roller is larger than the advancing speed of the first driving roller into the storage space, the first driving roller is kept from slipping relative to the article. Thus, the first driving roller and the article are protected from damage.

In another preferred embodiment of the present invention, the first driving roller retracts from one of the storage spaces, while rotating in the direction for transferring the article into the storage space, to transfer the article from the bucket body into the storage space.

When the first driving roller retracts from one of the storage spaces, while rotating in the direction for transferring the article into the storage space, the first driving roller can reliably leave the article in the storage space.

In another preferred embodiment of the present invention, the circumferential speed of the outer circumferential surface of the rotating first driving roller is larger than the retracting speed of the first driving roller from the storage space.

When the circumferential speed of the outer circumferential surface of the rotating first driving roller is larger than the retracting speed of the first driving roller from the storage space, the first driving roller is kept from slipping relative to the article. Thus, the first driving roller and the article are protected from damage.

In another preferred embodiment of the present invention, the bucket is provided with a second driving roller disposed in the bucket body and the inlet/outlet slot is provided with a sensor for detecting the passage of the article. The second driving roller starts when the sensor detects the article passing by the sensor from the outside of the inlet/outlet slot distanced from the storage spaces to the inside of the inlet/outlet slot close to the storage spaces.

When the second driving roller disposed in the bucket body starts based on the detection of the article passing by the sensor from the outside of the inlet/outlet slot distanced from the storage spaces to the inside of the inlet/outlet slot close to the storage spaces, a returned article put in the inlet/outlet slot is reliably taken into the bucket body.

In another preferred embodiment of the present invention, the bucket is provided with a third roller disposed in the bucket body to collaborate with the second driving roller, thereby clamping the article. The third roller is resiliently supported by the bucket body to move toward and away from the second driving roller.

When the second driving roller collaborates with the third roller to clamp the article, the article is prevented from being damaged by contact with the bucket body.

When the third roller is resiliently supported by the bucket body to move toward and away from the second driving roller, various kinds of articles with various thickness can be reliably taken into the bucket body and conveyed if only the arm can swing between a rest position where the first driving roller and the guide do not clamp the article and a working position where the first driving roller and the guide clamp the article.

In another preferred embodiment of the present invention, the bucket is provided with a pair of transmission type photo sensors disposed in the bucket body, and the article comprises a transparent or semitransparent case and a partially opaque article body held in the case. The pair of transmission type photo sensors detect shading when the article passes by the pair of the transmission type photo sensors to detect the fact in that the article body is stored in the case.

When the transmission type photo sensors detect the fact in that the article body is held in the case, an empty case holding no article body is kept from returning.

### BRIEF DESCRIPTION OF THE DRAWINGS

In the drawings:

FIG. 1 is a perspective view of an apparatus for conveying and storing DVD disks in accordance with a preferred embodiment of the present invention.

FIG. 2 is a perspective view of a body of stacked storage spaces provided in an apparatus for conveying and storing DVD disks in accordance with a preferred embodiment of the present invention.

FIG. 3 is a fragmentary enlarged sectional view of a body of stacked storage spaces provided in an apparatus for conveying and storing DVD disks in accordance with a preferred embodiment of the present invention.

FIG. 4 is a perspective view of a shelf forming a storage space provided in an apparatus for conveying and storing DVD disks in accordance with a preferred embodiment of the present invention.

FIG. 5 is a perspective view of an apparatus for conveying and storing DVD disks in accordance with a preferred embodiment of the present invention, wherein the front door is removed.

FIG. 6 is a sectional view of a bucket provided in an apparatus for conveying and storing DVD disks in accordance with a preferred embodiment of the present invention.

FIG. 7 is a perspective view of a bucket provided in an apparatus for conveying and storing DVD disks in accordance with a preferred embodiment of the present invention.

FIG. 8 is a perspective view of a bucket provided in an apparatus for conveying and storing DVD disks in accordance with a preferred embodiment of the present invention.

FIG. 9 is a sectional view of a bucket for explaining the operation of an apparatus for conveying and storing DVD disks in accordance with a preferred embodiment of the present invention.

FIG. 10 is a sectional view of a bucket for explaining the operation of an apparatus for conveying and storing DVD disks in accordance with a preferred embodiment of the present invention.

FIG. 11 is a side view of a bucket for explaining the operation of an apparatus for conveying and storing DVD disks in accordance with a preferred embodiment of the present invention.

FIG. 12 is a side view of a bucket for explaining the operation of an apparatus for conveying and storing DVD disks in accordance with a preferred embodiment of the present invention.

FIG. 13 is a side view of a bucket for explaining the operation of an apparatus for conveying and storing DVD disks in accordance with a preferred embodiment of the present invention.

FIG. 14 is a side view of a bucket for explaining the operation of an apparatus for conveying and storing DVD disks in accordance with a preferred embodiment of the present invention.

FIG. 15 is a side view of a bucket for explaining the operation of an apparatus for conveying and storing DVD disks in accordance with a preferred embodiment of the present invention.

### DETAILED DESCRIPTION OF THE PREFERRED EMBODIMENTS

A preferred embodiment of the present invention implemented in an apparatus for conveying and storing DVD disks will be described.

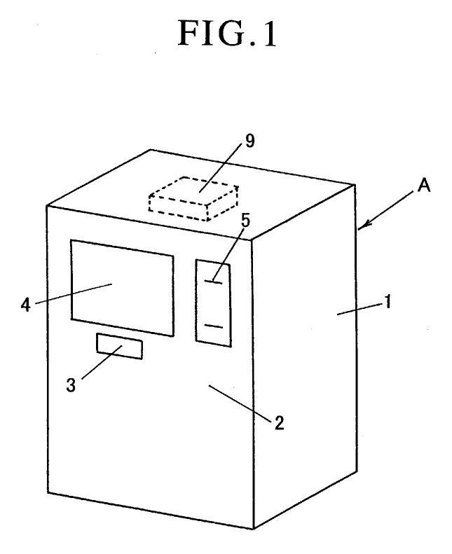

As shown in FIG. 1, an apparatus A for conveying and storing DVD disks comprises a thin box-shaped case 1 open at the front and a swing door 2 for covering the open front of the case 1. The door 2 is provided with a DVD inlet/outlet slot 3, a touch panel type manipulable display 4 and a coin slot 5.

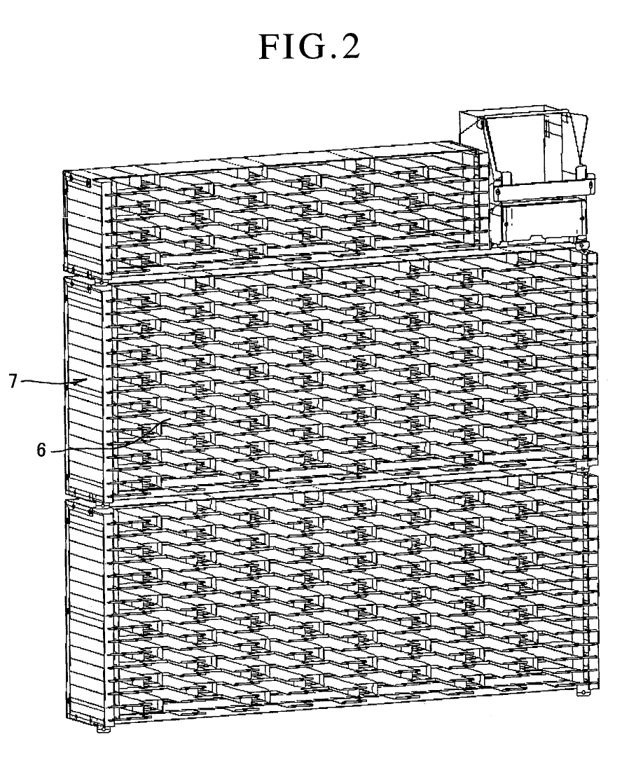

As shown in FIG. 2, many storage spaces 6 for receiving DVD cases holding DVD disks are multiply stacked vertically and transversely (horizontally) to form an assembly 7 of stacked storage spaces.

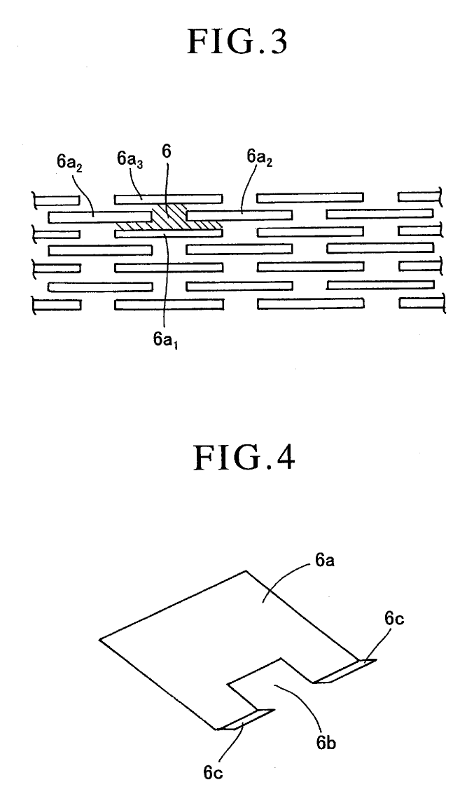

As shown in FIG. 3, each storage space 6 is provided with a shelf 6a for horizontally supporting a DVD case. Vertically adjacent tires of shelves 6a are laterally staggered so that vertically adjacent shelves 6a overlap each other at opposite transverse ends. As a result, the vertical space between two shelves 6a in face to face opposition is, at the transverse middle thereof, twice as large as the vertical space between two adjacent shelves 6a. A given storage space 6, which is indicated by crosshatching in FIG. 3, is formed by the space enclosed by a given shelf 6a₁, two shelves 6a₂ included in the tier of shelves located just above the tier of shelves including the shelf 6a₁, and a shelf 6a₃ included in the tire of shelves located above the tier of shelves including the shelf 6a₁ by tow tiers and located in face to face opposition to the shelf 6a₁. Therefore, vertically adjacent tires of the storage spaces 6 are laterally staggered in such a manner that the storage spaces 6 in the upper tier and the storage spaces 6 in the lower tier vertically overlap at the opposite transverse ends. The height of the storage space 6 is larger at the transverse middle than at the opposite transverse ends.

As shown in FIG. 4, the shelf 6a is provided with a cutout 6b at the transverse middle of the end close to the inlet of the storage space 6. The end portion of the shelf 6a close to the inlet of the storage space 6 is bent upward at the opposite transverse ends to form upward projections 6c.

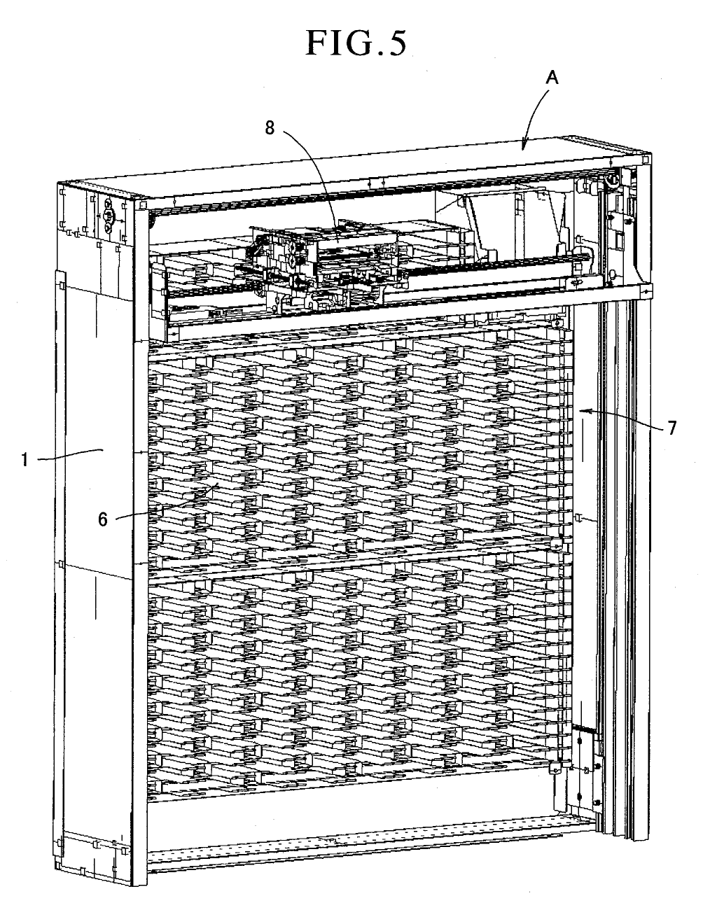

As shown in FIG. 5, the assembly 7 of stacked storage spaces is disposed in the case 1.

As shown in FIG. 5, a bucket 8 is disposed in the case 1 to be located in front of the assembly 7 of stacked storage spaces. The bucket 8 moves vertically, transversely and longitudinally to convey a DVD case inserted into the DVD inlet/outlet slot 3 to a storage space 6 and convey a DVD case stored in a storage space 6 to the DVD inlet/outlet slot 3.

As shown in FIG. 1, the display 4 and a controller 9 for controlling the operation of the bucket 8 are disposed at the upper portion of the case 1.

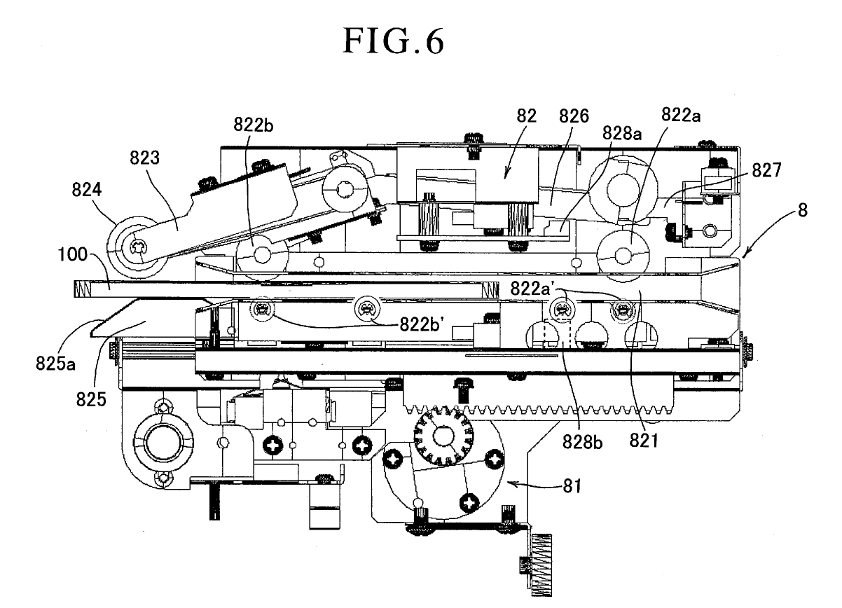

As shown in FIGS. 6 to 8, the bucket 8 comprises a base 81 movable vertically and transversely and a bucket body 82 driven by a rack-pinion drive mechanism to move longitudinally relative to the base 81.

The bucket 8 further comprises a DVD case passage 821 disposed in the bucket body 82, a pair of conveying rollers 822a and a pair of conveying rollers 822b longitudinally distanced from each other and located just above the DVD case passage 821 so that their lower portions project into the DVD case passage 821. The bucket 8 further comprises two pairs of driven rollers 822a′ and two pairs of driven rollers 822b′ longitudinally distanced from each other and located just below the DVD case passage 821 so that their upper portions project into the DVD case passage 821. The driven rollers 822a′ and 822b′ are resiliently supported in the vertical direction by the bucket body 82 through springs not shown in Figures. Thus, the driven rollers 822a′ and 822b′ can move toward and away from the conveying rollers 822a and 822b.

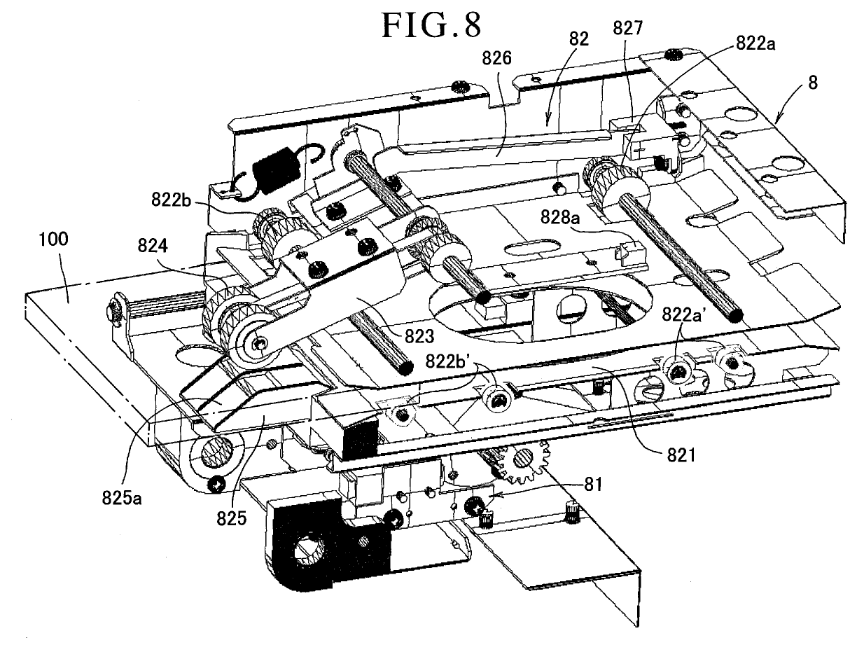

The bucket 8 further comprises an arm 823 projecting rearward from the bucket body 82, pick-up rollers 824 provided at the tip of the arm 823 and a guide 825 located below the pick-up rollers 824 and projecting rearward from the bucket body 82. The guide 825 is provided with a slant upper surface 825a at the tip portion. The slant upper surface 825a inclines downward in the rearward direction. As shown in FIGS. 6 and 8, the pick-up rollers 824 can collaborate with the guide 825 to clamp a DVD case 100.

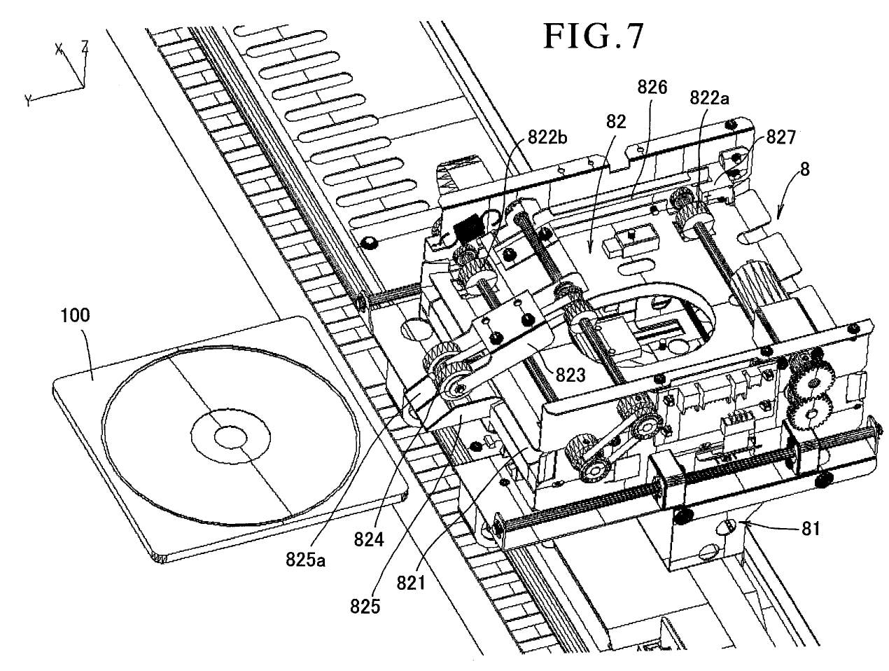

The arm 823 can swing between a rest position where, as shown in FIG. 7, the pick-up rollers 824 and the guide 825 do not clamp the DVD case 100 and a working position where, as shown in FIGS. 6 and 8, the pick-up rollers 824 and the guide 825 clamp the DVD case 100. The swing of the arm 823 is transmitted to a lever 826 unitarily assembled with the arm 823 and disposed in the bucket body 82. The bucket 8 is provided with a sensor 827 disposed in the bucket body 82. The sensor 827 detects the swing of the lever 826 to detect the swing of the arm 823.

The bucket 8 is provided with a pair of transmission type photo sensors 828a and 828b disposed in the bucket body 82 and vertically opposite each other with the DVD passage 821 lying between them.

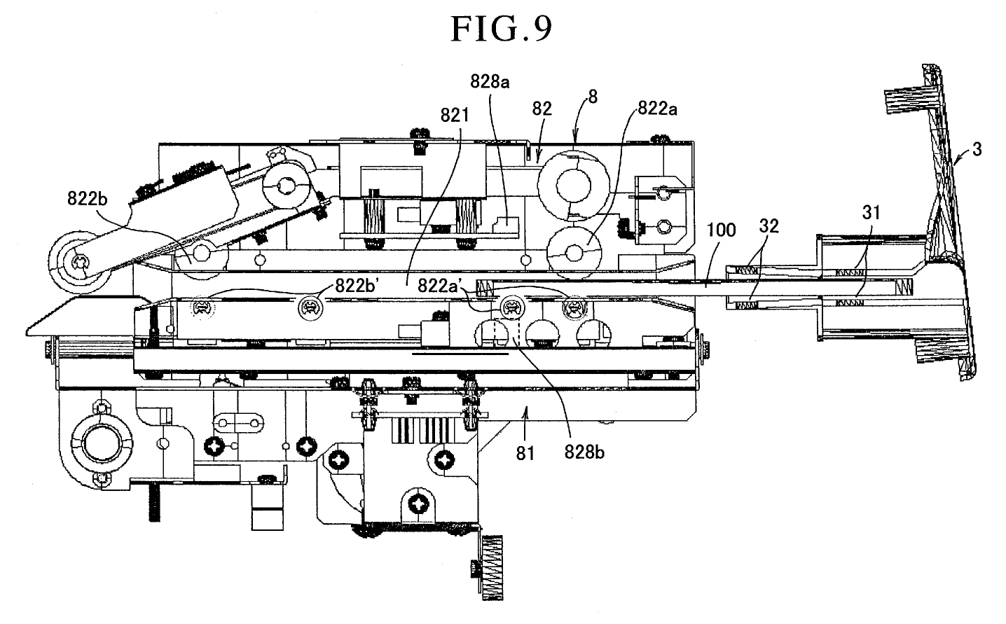

As shown in FIG. 9, the DVD inlet/outlet slot 3 is provided with a pair of sensors 31 vertically opposite each other and a pair of sensors 32 vertically opposite each other. The sensors 31 and 32 are longitudinally distanced from each other. The sensors 31 and 32 detect the DVD case 100 as it passes thereby from the outside of the inlet/outlet slot 3 distanced from the storage spaces 6 to the inside of the inlet/outlet slot 3 close to the storage spaces 6.

Operations of the DVD conveying and storing apparatus A will be described referring to FIGS. 9 to 15.

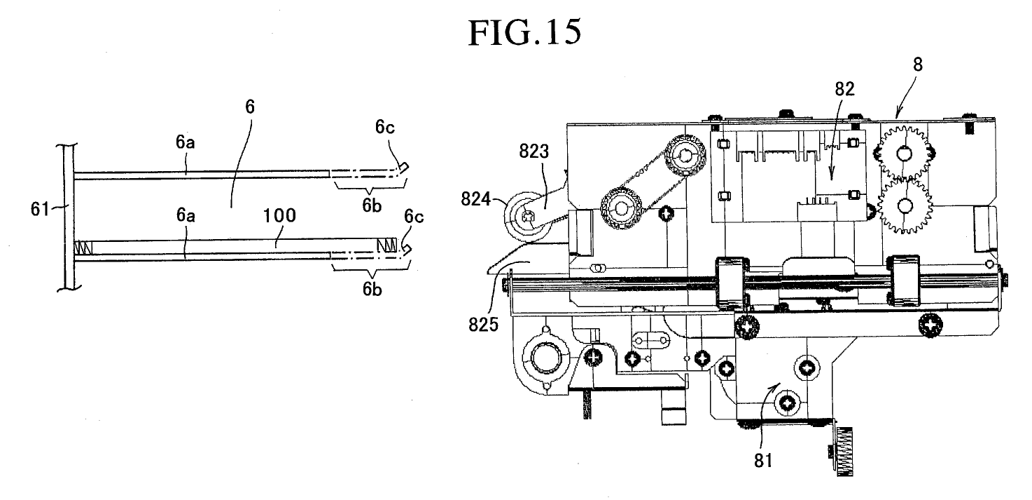

Each storage space 6 is adapted to receive one DVD case 100 made of transparent or semitransparent material. The DVD case 100 holds a DVD disk at least a part whereof is made of opaque material. As can be seen from FIG. 15, the DVD case 100 is placed on the shelf 6a to be horizontally supported by the shelf 6a. The rear end of the DVD case 100 abuts a rear end wall 61 of the storage space 6. The shelf 6a is provided with upward projections 6c at the end close to the inlet of the storage space 6. Therefore, the DVD case 100 does not fall out of the storage space 6 even if the DVD conveying and storing apparatus A inclines forward, i.e., toward the inlet of the storage space 6.

When a user manipulates the display 4 to designate a desired DVD, the bucket 8 standing by in the rest position opposite the DVD inlet/outlet slot 3 moves vertically and transversely under the control by the controller 9. Thus, as shown in FIG. 15, the bucket 8 comes to a position opposite the storage space 6 in which the DVD case 100 holding the designated DVD disk is stored.

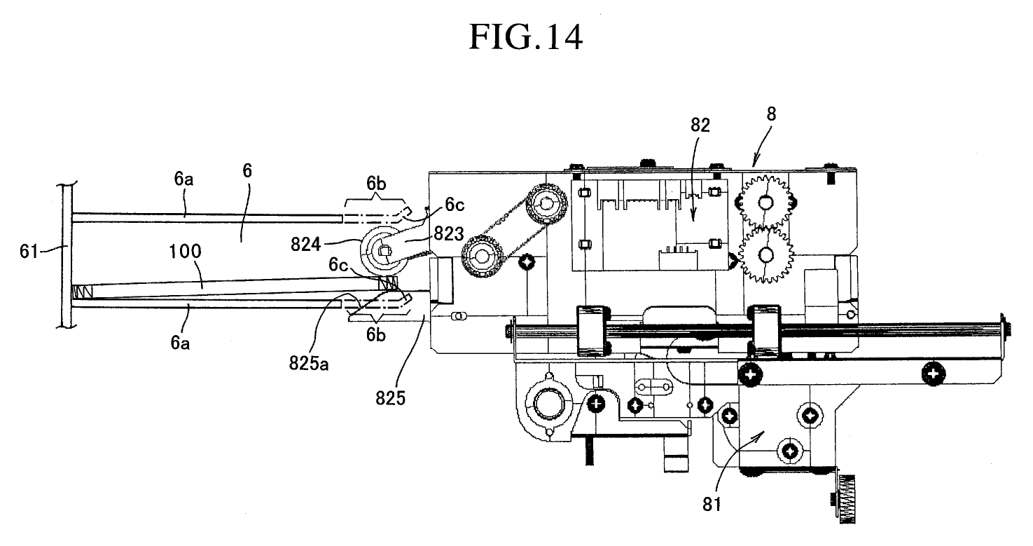

As shown in FIG. 14, the bucket body 82 moves rearward relative to the base 81 and the pick-up rollers 824 and the guide 825 enter the storage space 6, with the pick-up rollers 824 and the conveying rollers 822a and 822b rotating in the direction for taking the DVD case 100 into the bucket body 82. The pick-up rollers 824 and the guide 825 can easily enter the storage space 6 because they enter the transverse middle of the storage space 6 where the storage space 6 has a large height. The guide 825 does not interfere with the shelf 6a because it moves in the cutout 6b formed in the shelf 6a.

The slant upper surface 825a of the guide 825 abuts the front end of the DVD case 100 to guide the front end of the DVD case 100 to the pick-up rollers 824. The crest of the slant upper surface 825a is located above the shelf 6a, more exactly above the top of the upward projections 6c. Therefore, the DVD case 100 is reliably guided to the pick-up rollers 824. The pick-up rollers 824 engage the front end of the DVD case 100. The pick-up rollers 824 collaborate with the guide 825 to clamp the front end of the DVD case 100.

The pick-up rollers 824 can smoothly clamp the front end of the DVD case 100 in the collaboration with the guide 825 because they rotate in the direction for taking the DVD case 100 into the bucket body 82.

When the pick-up rollers 824 and the guide 825 collaborate with each other to clamp the front end of the DVD case 100, the arm 823 swings from the rest position to the working position. The sensor 827 detects the swing of the arm 823 from the rest position to the working position through the lever 826 and the start of the operation for taking the DVD case 100 from the storage space 6 into the bucket body 82 is detected.

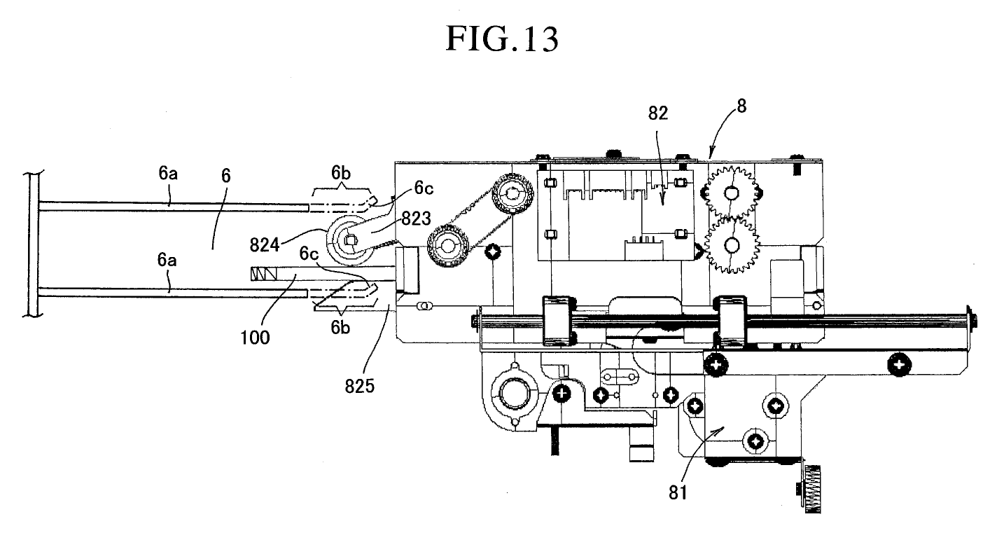

As shown in FIG. 13, the rotating pick-up rollers 824 drive the DVD case 100 to take it into the DVD passage 821 of the bucket body 82. The DVD case 100 is reliably taken from the storage space 6 into the bucket body 82 because the pick-up rollers 824 and the guide 825 clamp the DVD case 100. The conveying rollers 822b engage the DVD case 100, collaborate with the pick-up rollers 824 to drive the DVD case 100, collaborate with the driven rollers 822b′ to clamp the DVD case 100, and take the DVD case 100 to the longitudinal middle of the DVD passage 821. The transmission type photo sensors 828a and 828b detect the opaque part of the DVD disk held in the DVD case 100. The pick-up rollers 824 and the conveying rollers 822a and 822b keep rotating for a predetermined period from the moment when the transmission type photo sensors 828a and 828b detect the opaque part of the DVD disk in the DVD case 100, thereby taking the whole DVD case 100 into the DVD passage 821. The conveying rollers 822a and 822b and the driven rollers 822a′ and 822b′ clamp the DVD case 100. The pick-up rollers 824 and the conveying rollers 822a and 822b stop rotating.

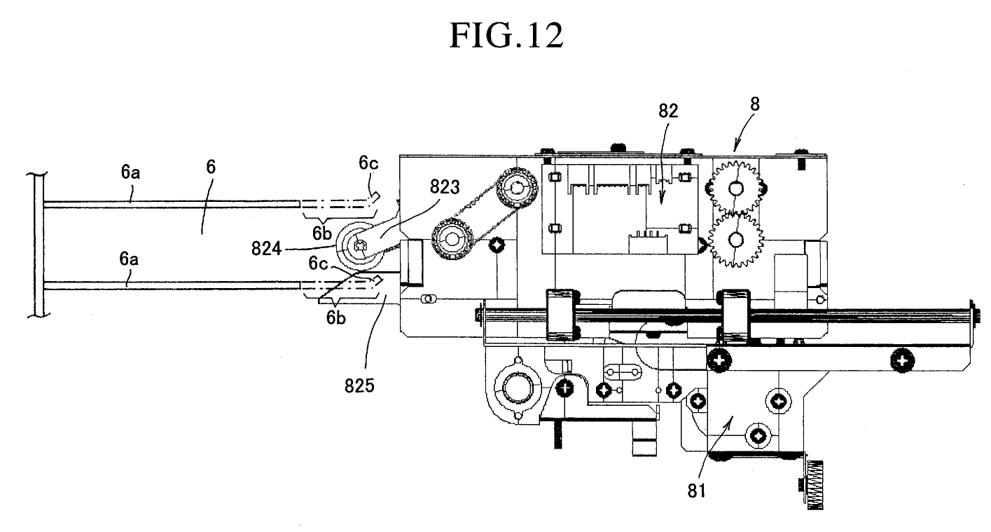

As shown in FIG. 12, the whole DVD case 100 is taken into the DVD passage 821, the pick-up rollers 824 and the guide 825 stop clamping the DVD case 100, and the arm 823 swings from the working position to the rest position. The sensor 827 detects the swing of the arm 823 from the working position to the rest position through the lever 826, thereby reliably detecting the completion of the operation for taking the DVD case 100 from the storage space 6 into the bucket body 82.

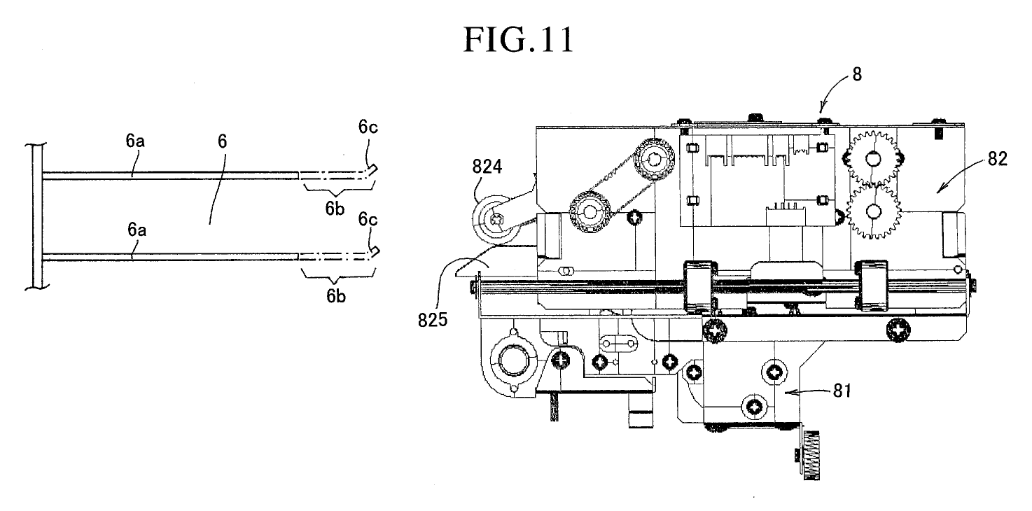

As shown in FIG. 11, the bucket body 82 moves forward relative to the base 81 and the pick-up rollers 824 and the guide 825 retract from the storage space 6.

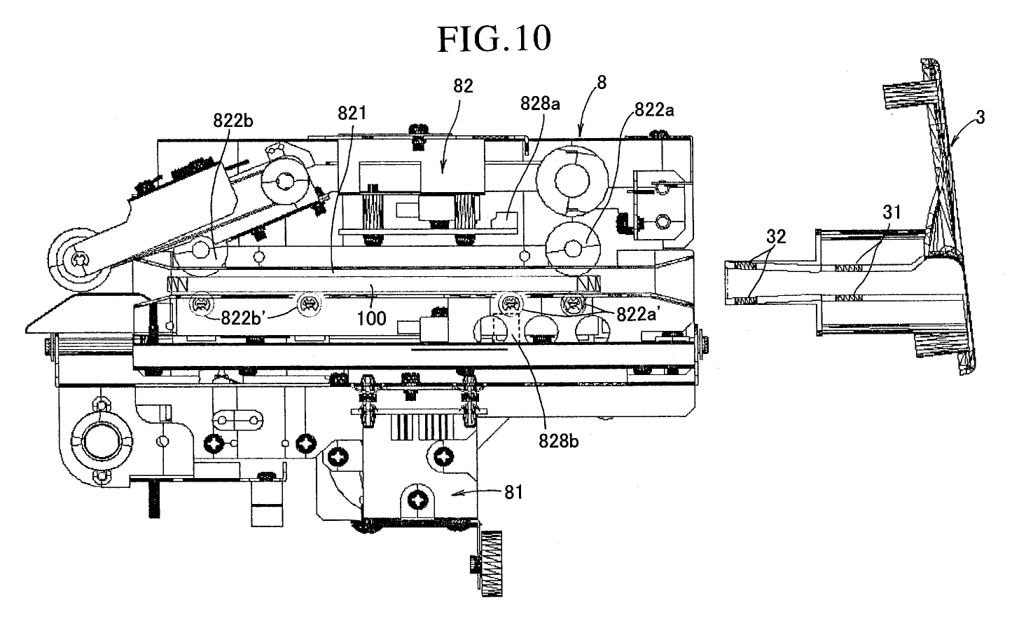

The bucket 8 moves vertically and transversely and, as shown in FIG. 10, comes to a position opposite the DVD inlet/outlet slot 3. As shown in FIG. 9, the conveying rollers 822a and 822b rotate to drive the DVD case 100 in the DVD passage 821 toward the DVD inlet/outlet slot 3. The conveying rollers 822a and 822b keep rotating for a predetermined period from the moment when the transmission type photo sensors 828a and 828b come to be unable to detect the opaque part of the DVD disk in the DVD case 100 any more, thereby transferring the whole DVD case 100 out the DVD passage 821, and carrying the DVD case 100 out to the DVD inlet/outlet slot 3. The conveying rollers 822a and 822b stop rotating.

The bucket 8 stays in the rest position opposite the DVD inlet/outlet slot 3.

When a user inserts a DVD case 100 holding a DVD disk to be returned into the DVD inlet/outlet slot 3, the sensors 31 and 32 detect the DVD case 100 passing by them from the outside of the inlet/outlet slot 3 distanced from the storage spaces 6 to the inside of the inlet/outlet slot 3 close to the storage spaces 6, the conveying rollers 822a and 822b of the bucket 8 standing by in the rest position opposite the DVD inlet/outlet slot 3 start rotation, and, as shown in FIG. 9, the conveying rollers 822a and 822b take the DVD case 100 into the DVD passage 821.

When the DVD case 100 to be returned is inserted into the DVD inlet/outlet slot 3, it can be reliably taken into the bucket body 82 because the conveying rollers 822a and 822b disposed in the bucket body 82 start rotation when the sensors 31 and 32 detect the DVD case 100 passing by them from the outside of the inlet/outlet slot 3 distanced from the storage spaces 6 to the inside of the inlet/outlet slot 3 close to the storage spaces 6.

The conveying rollers 822a and 822b keep rotating for a predetermined period from the moment when the transmission type photo sensors 828a and 828b detect the opaque part of the DVD disk in the DVD case 100 and detect that the DVD case 100 holds the DVD disk. Thus, as shown in FIG. 10, the whole DVD case 100 is taken into the DVD passage 821. The conveying rollers 822a and 822b and the driven rollers 822a′ and 822b′ clamp the DVD case 100. The conveying rollers 822a and 822b stop rotating. If the transmission type photo sensors 828a and 828b do not detect the opaque part of the DVD disk in the DVD case 100, the DVD case 100 is judged to be empty and carried out of the bucket body 82 to the DVD inlet/outlet slot 3. Therefore, an empty DVD case 100 cannot be received in the storage space 6.

The bucket 8 moves vertically and transversely and, as shown in FIG. 11, comes to a position opposite an empty storage space 6. As shown in FIG. 12, the bucket body 82 moves rearward relative to the base 81 and the pick-up rollers 824 and the guide 825 enter the storage space 6.

The conveying rollers 822a and 822b and the pick-up rollers 824 rotate, the pick-up rollers 824 and the guide 825 clamp the rear end portion of the DVD case 100, and, as shown in FIG. 13, transfer the DVD case 100 from the DVD passage 821 of the bucket body 82 into the storage space 6. The crest of the slant upper surface 825a of the guide 825 is located above the shelf 6a, more exactly above the top of the upward projections 6c. Therefore, the DVD case 100 is reliably transferred into the storage space 6 without interfering with the upward projections 6c. The pick-up rollers 824 and the guide 825 clamp the DVD case 100 to reliably transfer the DVD case 100 from the bucket body 82 into the storage space 6. When the pick-up rollers 824 and the guide 825 collaborate to clamp the rear end portion of the DVD case 100, the arm 823 swings from the rest position to the working position. The swing of the arm 823 from the rest potion to the working position is detected by the sensor 827 through the lever 826. Thus, the start of the operation for transferring the DVD case 100 from the bucket body 82 into the storage space 6 is detected.

The conveying rollers 822a and 822b and the pick-up rollers 824 keep rotating even after the moment when the transmission type photo sensors 828a and 828b come to be unable to detect the opaque part of the DVD disk in the DVD case 100 any more. Thus, as shown in FIG. 14, the whole DVD case 100 is transferred out of the bucket body 82 into the storage space 6. The rear end of the DVD case 100 abuts the rear end wall 61 of the storage space 6.

The bucket body 82 moves forward relative to the base 81. The pick-up rollers 824 retract from the storage space 6 together with the guide 825, while rotating in the direction for transferring the DVD case 100 into the storage space 6. Therefore, the pick-up rollers 824 and the guide 825 can reliably leave the DVD case 100 in the storage space 6.

As shown in FIG. 1a, the whole DVD case 100 is transferred into the storage space 6, the pick-up rollers 824 and the guide 825 retract from the storage space 6, and the pick-up rollers 824 and the guide 825 finish clamping the DVD case 100. The arm 823 swings from the working position to the rest position. The swing of the arm 823 from the working position to the rest position is detected by the sensor 827 through the lever 826. Thus, the completion of the operation for transferring the DVD case 100 from the bucket body 82 into the storage space 6 is reliably detected. The conveying rollers 822a and 822b and the pick-up rollers 824 stop rotating.

The bucket 8 moves vertically and transversely to return to the rest position opposite the DVD inlet/outlet slot 3 and stays there.

As can be seen from the foregoing explanation, in the apparatus A for conveying and storing articles, the pick-up rollers 824 provided on the arm 823 projecting from the bucket body 82 and the guide 825 projecting from the bucket body 82 enter one of the storage spaces 6 to clamp a DVD case 100. Thus, the pick-up rollers 824 can clamp the DVD case 100 without collaborating with a structural member of the storage space 6. Therefore, the DVD case 100 can be reliably taken from the storage space 6 into the bucket body 82 or be transferred from the bucket body 82 into the storage space 6 even if the structural member of the storage space 6 deforms a little. The clamping of the DVD case 100 by the pick-up rollers 824 and the guide 825 can be easily kept stable by sufficiently enhancing the strength of the guide 825.

In the apparatus A for conveying and storing articles, the bucket 8 is provided with conveying mechanisms for transferring the DVD case 100 from the bucket 8 into the storage space 6 and taking the DVD case 100 from the storage space 6 into the bucket 8, i.e., the conveying rollers 822a and 822b and the pick-up rollers 824. Therefore, the number of the conveying mechanisms does not increase even if the number of the storage spaces 6 increases.

Since the vertically adjacent storage spaces 6 are laterally staggered, each storage space 6 can have a large height at the transverse middle. As a result, there can be provided a compact apparatus A for conveying and storing articles comprising an assembly of stacked storage spaces 6 compact in vertical size and a bucket 8 provided with a conveying mechanism, i.e., the pick-up rollers 824, for transferring the DVD case 100 from the bucket 8 into the storage space 6 and taking the DVD case 100 from the storage space 6 into the bucket 8.

Since the conveying rollers 822a and 822b collaborate with the driven rollers 822a′ and 822b′ to clamp the DVD case 100, the DVD case 100 is prevented from being damaged by contact with the bucket body 82.

Since the driven rollers 822a′ and 822b′ are resiliently supported by the bucket body 82 to move toward and away from the conveying rollers 822a and 822b, and the arm 823 projecting from the bucket body 82 can swing between a rest position where the pick-up rollers 824 and the guide 825 do not clamp the DVD case 100 and a working position where the pick-up rollers 824 and the guide 825 clamp the DVD case 100, various kinds of DVD cases with various thickness can be reliably taken into the bucket body 82 to be conveyed.

The projections 6c can be formed by fixing independent projections on the opposite transverse ends of the front end of the shelf 6a close to the inlet of the storage space 6 instead of by bending the opposite transverse ends of the front end of the shelf 6a close to the inlet of the storage space 6. It is possible to slant the shelf 6a downward in the direction to the rear end of the storage space 6. When the shelf 6 is slanted downward in the direction to the rear end of the storage space 6, the DVD case 100 is kept from falling out of the storage space 6 even if the apparatus A for conveying and storing articles is inclined toward the inlet of the storage space 6 for some reason.

It is possible to set the circumferential speed of the outer circumferential surface of the rotating pick-up rollers 824 larger than the advancing speed of the pick-up rollers 824 into the storage space 6. The pick-up rollers 824 are kept from slipping relative to the DVD case 100 and the pick-up rollers 824 and the DVD case 100 are protected from damage.

It is possible to set the circumferential speed of the outer circumferential surface of the rotating pick-up rollers 824 larger than the retracting speed of the pick-up rollers 824 from the storage space 6. The pick-up rollers 824 are kept from slipping relative to the DVD case 100 and the pick-up rollers 824 and the DVD case 100 are protected from damage.

The present invention is suitable for use in apparatuses for conveying and storing regular shape articles like CDs held in flat box-shaped cases, the flat box-shaped cases themselves, flat box-shaped articles, etc.

While the present invention has been described with reference to preferred embodiments, one of ordinary skill in the art will recognize that modifications and improvements may be made while remaining within the spirit and scope of the present invention. The scope of the invention is determined solely by the attached claims.

1. An apparatus for conveying and storing articles comprising an inlet/outlet slot, a plurality of storage spaces stacked vertically and transversely, and a movable bucket for conveying an article from the inlet/outlet slot to one of the storage spaces and conveying an article from one of the storage spaces to the inlet/outlet slot, wherein the bucket comprises a bucket body, an arm projecting from the bucket body, a first driving roller provided on the arm and a guide projecting from the bucket body, and wherein the first driving roller and the guide enter one of the storage spaces to clamp an article, thereby enabling the article to be transferred from the bucket into the storage space and be taken from the storage space into the bucket.

2. An apparatus for conveying and storing articles of claim 1, wherein vertically adjacent tires of storage spaces are laterally staggered.

3. An apparatus for conveying and storing articles of claims 1 or 2, wherein each of the storage spaces is provided with a shelf for supporting the article and the shelf is provided with an upward projection at the end close to the inlet of the storage space.

4. An apparatus for conveying and storing articles of claims 1 or 2, wherein each of the storage spaces is provided with a shelf for supporting the article and the shelf is slanted downward in the direction to the rear end of the storage space.

5. An apparatus for conveying and storing articles of any one of claims 1 to 4, wherein the guide is located below the first driving roller and provided with a downward slant upper surface at the tip portion.

6. An apparatus for conveying and storing articles of claims 3 or 4, wherein the guide is located below the first driving roller and provided with a downward slant upper surface at the tip portion and the crest of the downward slant upper surface of the guide is located above the shelf when the first driving roller and the guide enter one of the storage spaces to transfer the article from the bucket body into the storage space, or take the article from the storage space into the bucket body.

7. An apparatus for conveying and storing articles of claims 5 or 6, wherein the arm projecting from the bucket body can swing between a rest position where the first driving roller and the guide do not clamp the article and a working position where the first driving roller and the guide clamp the article, and wherein the swing of the arm from the working position to the rest position is detected by a sensor, thereby detecting the completion of the operation for transferring the article from the bucket body into the storage space and the completion of the operation for taking the article from the storage space into the bucket body.

8. An apparatus for conveying and storing articles of any one of claims 1 to 7, wherein the first driving roller enters one of the storage spaces, while rotating in the direction for taking the article into the bucket body, to take the article into the bucket body.

9. An apparatus for conveying and storing articles of claim 8, wherein the circumferential speed of the outer circumferential surface of the rotating first driving roller is larger than the advancing speed of the first driving roller into the storage space.

10. An apparatus for conveying and storing articles of any one of claims 1 to 9, wherein the first driving roller goes out from one of the storage spaces, while rotating in the direction for transferring the article into the storage space, to transfer the article from the bucket body into the storage space.

11. An apparatus for conveying and storing articles of claim 10, wherein the circumferential speed of the outer circumferential surface of the rotating first driving roller is larger than the retracting speed of the first driving roller from the storage space.

12. An apparatus for conveying and storing articles of any one of claims 1 to 11, wherein the bucket is provided with a second driving roller disposed in the bucket body, the inlet/outlet slot is provided with a sensor for detecting the article passing by the sensor, and wherein the second driving roller starts when the sensor detects the article passing by the sensor from the outside of the inlet/outlet slot distanced from the storage spaces to the inside of the inlet/outlet slot close to the storage spaces.

13. An apparatus for conveying and storing articles of claim 12, wherein the bucket is provided with a third roller disposed in the bucket body to collaborate with the second driving roller, thereby clamping the article, and wherein the third roller is resiliently supported by the bucket body to move toward and away from the second driving roller.

14. An apparatus for conveying and storing articles of any one of claims 1 to 13, wherein the bucket is provided with a pair of transmission type photo sensors disposed in the bucket body, and the article comprises a transparent or semitransparent case and a partially opaque article body held in the case, and wherein the pair of transmission type photo sensors detect shading when the article passes by the pair of transmission type photo sensors to detect the fact in that the article body is held in the case.
